(19) United States
(12) Patent Application Publication
(10) Pub. No.: US 2002/0133472 A1
(43) Pub. Date: Sep. 19, 2002

(54) System, method, and software for reducing postage costs by consolidating mailings

(76) Inventor: Norman H. Stepno, Alexandria, VA (US)

Correspondence Address: BACON & THOMAS, PLLC, 4th Floor, 625 Slaters Lane, Alexandria, VA, 22314-1176, US

(21) Appl. No.: 09/805,905

(22) Filed: Mar. 15, 2001

(51) Int. Cl. G01G 19/413; G07B 17/02; G06F 17/00

(52) U.S. Cl. 705/407; 705/401

(57) ABSTRACT

A system, method, and software re-arranges or modifies a master mailing list used by software-controlled mail preparation apparatus in order to re-schedule mailings to the same address so that they can be combined, thereby reducing costs associated with separate mailings.

### BACKGROUND OF THE INVENTION

1. Field of the Invention

This invention relates generally to systems and methods for assembling mailings in preparation for delivery to a mail carrier, and to software for implementing such systems and methods. More particularly, the invention relates to an improvement to automated mailing systems and methods arranged to handle large numbers of individualized mail pieces such as account statements or invoices with the assistance of software-controlled mechanisms that address envelopes, print or prepare documents for mailing, and insert the documents in the envelopes.

The improvement provides a system, method, and software that revises the mailing schedule used by the software-controlled mechanisms in order to consolidate mailings to the same address, and thereby save postage and other costs associated with the mailings, while taking into account scheduling requirements imposed by the nature and purpose of a specific mailing.

2. Description of Related Art

Most organizations that generate large numbers of mailings, including financial services companies, non-profit organizations, and governmental agencies, now utilize automated systems to handle printing and preparation of documents for mailing. The systems handle addressing of envelopes, association and insertion of the documents into the envelopes, and tasks related to preparation of the assembled envelopes for delivery to a mail carrier, including adding postage to the envelopes and, in the United States, pre-sorting of the envelopes by zip code or region.

Typically, the automated systems are part of a mailing center that handles requests for mailing from dispersed and often essentially independent corporate divisions, or even from multiple companies or organizations, with no coordination between the sources of the requests. As a result, most of the document preparation and mailing functions are handled at the center. In many cases, the documents to be placed in the mailings are printed and assembled at the mailing center based on pre-stored templates, with only a minimal amount of data or records being transmitted over secured communications lines from sources outside the mailing center.

For example, the corporate mailing center of a financial services corporation may be required to print different brokerage, credit card, and bank account statements based solely on received account records that contain nothing more than the name of the account holder and account activity summaries. The mailing center inserts the account activity summaries into an account statement template, adds names and addresses from its own database, with address change requests being routed directly to the mailing center, and schedules mailings based on resource availability and pre-established priorities. Since records or data related to the different types of accounts originates from dispersed, uncoordinated source divisions, the mailing center will normally maintain separate records for each type of statement. The records are then assembled at the mailing center by a master mailing control program into a single mailing list.

While scheduling of mailings must ultimately be determined by the mailing center based on resource availability, the mailings often must occur within a specified time window, determined by the source of the account data or records supplied to the mailing center. The time window ensures timeliness of the content of the mailing, and/or affords the party at the destination address sufficient time to respond to the mailing by a due date. Because this externally-imposed time limitation can result in conflicts between mailings, the master program must prioritize the list of destination addresses and documents to be sent to those addresses.

A state-of-the-art mailing center thus not only has the capability of coordinating mailings, preparing documents, addressing envelopes, inserting the documents in envelopes, and delivering completed pre-sorted bundles to a mail carrier, but of assembling and adjusting the mailing list according to resource availability and external deadlines. Using such systems, and corresponding methods and software, the costs of preparing mailings have been significantly reduced in recent years. Nevertheless, as costs associated with preparation of mailings have decreased, postage costs have increased even faster, eliminating any net savings. Moreover, in many cases, the number of documents sent out per account holder has greatly increased, further adding to cost increases. Even with all of the recent improvements in mailing efficiency, the cost of mailings associated with an account often can make up more than half the total overhead associated with the account. There is thus a critical need, from the point of view of organizations that generate large numbers of mailings, for ways to further reduce costs associated with the mailings.

Conversely, there is also a critical need, from the point of view of consumers and those who wish to communicate with them, to reduce the number of mailings that received by the consumers. A household including customers of a financial services company such as Merrill Lynch & Co., Inc., might receive five or more separate mailings, all on the same day or at various times during the month, for cash management, profit sharing, money market, and individual retirement accounts for both spouses. In response to the deluge of mailings to which a typical household is subject, many consumers have developed symptoms of a condition known as mail fatigue, characterized by an unwillingness or inability to open the piles of mail received every day. While a single monthly mailing from a company in which the consumer has one or more accounts is likely to be pulled out of the volumes of charitable solicitations, advertisements, and other “junk” mail, when multiple mailings are received from the same company, the chances that each of the mailings will be read decrease substantially, particularly if the mailings are not likely to contain invoices, and if access to accounts can be obtained through other means. As a result, mailing costs are essentially wasted, and the consumer is more annoyed than benefitted.

Numerous ways to improve the efficiency of mailings have previously been proposed. These include improvements in the machines and controllers that carry out document production or insertion of documents in envelopes (U.S. Pat. Nos. 5,612,888 (Chang et al.), U.S. Pat. No. 5,659,481 (Qutub et al.) and U.S. Pat. No. 5,873,073 (Bresnan et al.)), systems and methods for grouping different mailings by destination (U.S. Pat. No. 5,377,120 (Humes et al.)), systems and methods for distributing mailing tasks between different nodes (U.S. Pat. No. 5,918,220 (Sansone et al.)), mailpiece coding and tracking systems (U.S. Pat. No. 4,800,505 (Axelrod et al.) , systems and methods for elimination of duplication in mailing lists (U.S. Pat. Nos. 5,303,149 (Janigian) and U.S. Pat. No. 5,799,302 (Johnson et al.)), and systems and methods for co-mailing of similar documents from different sources, such as coupons or advertisements (U.S. Pat. No. 5,058,030 (Schumacher)).

Of the prior systems and methods disclosed in these patents for improving mailing efficiency or lowering costs, the only system and method that involves combination of mailings is the co-mailing system and method disclosed in the Schumacher patent. In the system and method of Schumacher, a third party mail processing center inserts advertising documents from multiple advertisers in a single envelope, or multiple envelopes in pre-sorted bundles, thereby enabling individual advertisers to take advantage of volume postal rates, and permitting postage costs to be optimized by assembling the co-mailings based on characteristics of the documents to be included, such as the weight of the documents, so that the envelopes can be filled to maximum allowable weight for a particular rate. However, the system and method of Schumacher has limited applicability to mailings involving diverse types of documents, and or mailings involving strict date restrictions, since the coupons or advertisements included in the co-mailings of Schumacher are typically uniformly sized documents that are intended to be mailed out at the same time. The co-mailer assembles the list of addressees at the center, and is free to send out mailings on any day to all or selected subgroups of addresses on the list. In contrast, in a typical mailing center, widely disparate mailings must be mailed out at different times, the mailings generally having nothing in common, whether subject matter or common promotional purpose, other than their handling by a common mail center.

Despite the sophistication of current mailing systems, corporations continue to send out statements, notices, and the like that are intended for the same address, and that might even be scheduled for mailing on the same day, in separate mailings. While the costs of each individual mailing might be optimized by further improvements to the mailing apparatus and corresponding control software, none of the systems described above is capable of achieving the savings possible with the present invention, namely the savings resulting from combining separate, unrelated mailings to a common address or addressee.

### SUMMARY OF THE INVENTION

It is accordingly a first objective of the invention to improve existing automated mailing systems and methods by providing a system, method, and software for re-scheduling mailings so that mailings originally scheduled to be separately may be consolidated in order to reduce costs.

It is a second objective of the invention to provide a system, method, and software for lowering mailing costs by consolidating mailings, and that takes into account date-related conditions on the different mailings to be consolidated.

It is a third objective of the invention to provide a system, method, and software for lowering mailing costs by consolidating mailings in a way that optimizes resource utilization, for example by ensuring that mailings have as much weight as possible within a particular postage rate category.

It is a fourth objective of the invention to provide a system, method, and software for lowering mailing costs in the context of a mailing center that serves a diverse set of clients, such as different divisions of a financial services company, and that interacts with the different clients by determining the most efficient mailing schedule in order to meet the needs of the different clients or divisions.

It is a fifth objective of the invention to benefit consumers by reducing the number of mailings received from a single company or organization.

It is a sixth objective of the invention to provide a method of reducing postage costs, and corresponding software, that can be implemented by appropriate programming of existing automated mailing machines, and that can be used in both in-house corporate mailing environments and third party mail centers.

These objectives are achieved, in accordance with the principles of a preferred embodiment of the invention, by providing a system, method, and software for re-arranging or modifying the master mailing list used by software-controlled mail preparation apparatus by re-scheduling multiple mailings to a same address so that they can be combined, thereby permitting diverse multiple mailings to be consolidated.

The system, method, and software of the invention may be applied to a conventional automated mailing system of the type including address and document printing devices, and at least one inserter for inserting printed documents in the corresponding envelopes under control of a master mailing control program, the master mailing control program referring to a list of associated documents and addresses contained in records supplied by a variety of sources.

Preferably, the mailings are consolidated in such a way as to take into account requirements that certain mailings be carried out on a certain date, or within a predetermined date window. To accomplish this, each record is assigned a date range or window, and mailings are consolidated in such a way as to ensure that each mailing is carried out in the appropriate window. If it is not possible to consolidate all mailings due to non-overlapping windows, then the system, method, and software of the invention may test various possible combination of mailings to determine which will result in the lowest cost.

Consolidation may be by address or addressee. In either case, the master mailing program can optionally utilize known algorithms for eliminating duplicate mailings and other features of existing automated mailing systems such as postage optimization by limiting the amount of materials to be inserted into an envelope to a particular weight range, enabling use of pre-sorting and other cost saving arrangements.

It will of course be appreciated that the invention is not to be limited to a particular type of automated sorting apparatus or computing environment. In addition, the address and document printing devices, inserter, and master mailing control program do not need to be situated in geographic proximity, and the date, weight, or other criteria may vary from location to location within a particular system.

More specifically, according to a first preferred embodiment of the invention, the system, method, and software of the invention simply sorts the list by addressee, and combines the mailings irrespective of scheduled date, and informs the source of individual mailing requests that the date has been changed.

On the other hand, according to a second preferred embodiment of the invention, individual records in the list of associated documents, addresses, and dates are assigned markers or variables indicative of document parameters for determining how many documents can be combined in a single envelope, and the control software limits the mailing accordingly.

Further, according to a third preferred embodiment of the invention, the system, method, and software of the invention includes a date window or range parameter, or mailing date restrictions, that limit the range of dates within which the mailing of a particular document can occur, so that only mailings with overlapping date windows or ranges are combined or consolidated.

Finally, according to a fourth preferred embodiment of the invention, the system, method, and software of the invention takes into account both weight and date restrictions or conditions in order to determine whether mailings can be combined. By making multiple passes over the data with different starting points, it is possible in this embodiment of the invention to check different combinations of mailings and determine which set of combinations is optimal from the standpoint of resource utilization and/or cost.

### BRIEF DESCRIPTION OF THE DRAWINGS

FIG. 1 is a block diagram of a system constructed in accordance with the principles of the invention.

FIG. 2 is a flowchart of the method and software of a first preferred embodiment of the invention.

FIG. 3 is a flowchart of the method and software of a second preferred embodiment of the invention.

FIG. 4 is a flowchart of the method and software of a third preferred embodiment of the invention.

FIG. 5 is a flowchart of the method and software of a fourth preferred embodiment of the invention.

### DETAILED DESCRIPTION OF THE PREFERRED EMBODIMENTS

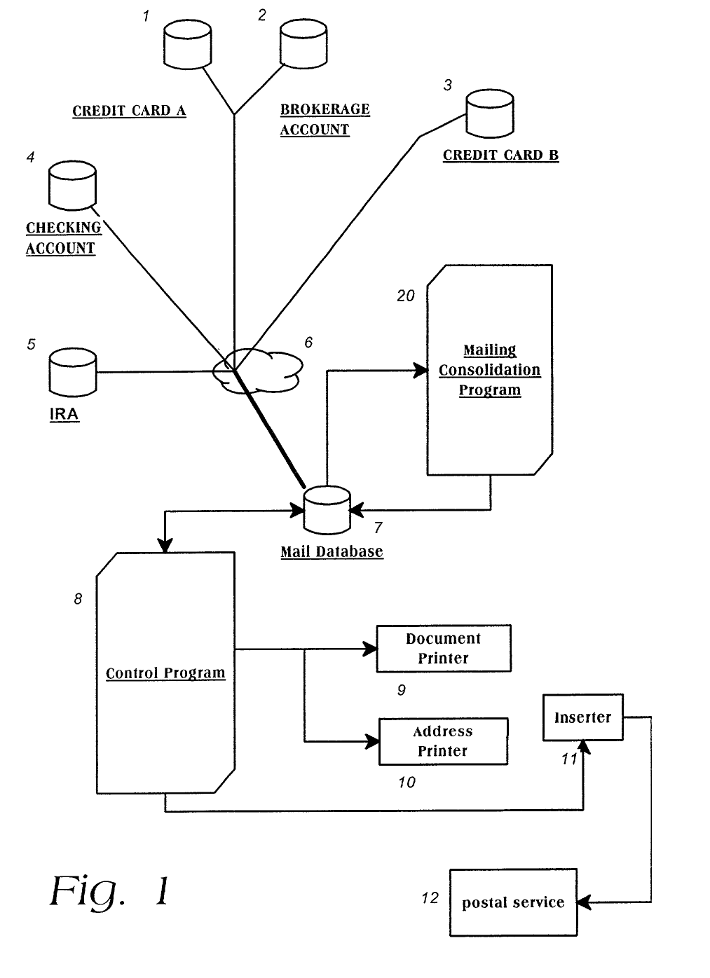

FIG. 1 is a schematic block diagram showing the principal components of a preferred system for consolidating mailings according to the principles of the invention. The system illustrated in FIG. 1 is, by way of example, a mailing system of the type utilized by a financial services company having a number of dispersed divisions or units arranged to maintain account information in databases 1-5, each division or unit being connected to a corporate mailing center via a communications network 6 such as an internal corporate network, a virtual private network, or a combination of private and secured public communications lines. The corporate mailing center is conventionally equipped with one or more databases 7 for storing information received from the separate divisions or units, and a control program 8 for maintaining the database and controlling various mechanisms arranged to carry out tasks associated with mailing. The various mechanisms may include, without limitation, document printer 9, envelope printer 10, and inserter 11, as well as any equipment necessary to sort and bundle mail for delivery to a mail carrier such as the U.S. Postal Service.

As illustrated, the control program 8 causes documents and envelopes to be printed, and controls the inserters to insert documents in envelopes, although it is also possible to print documents at locations other than the corporate mail center, and physically deliver them to the mail center for insertion into addressed envelopes. Database 7 contains a list of associated documents and addresses organized by the dates on which the address and documents are to be printed and associated by the inserter. The database software may include separate programs or subroutines arranged to delete duplicate entries for a particular mailing, update addresses or other information, and associate particular records or entries with information originating at the mail center, including documents weights or numbers of pages.

In addition to elements 7-12, each of which may be conventional, the preferred system illustrated in FIG. 1 includes mail consolidation software 20 that consolidates mailings according to the principles described below. Software 20 may be a subroutine or addition to the main control program, or may be a separate program, and of course includes object and/or source code written in any format and/or programming language required by the computing system on which it is run. Those skilled in the art will appreciate that once the functions of the software described below are understood, implementation is a matter of routine computer programming, and that the software will be described only in term of method steps implemented by the software.

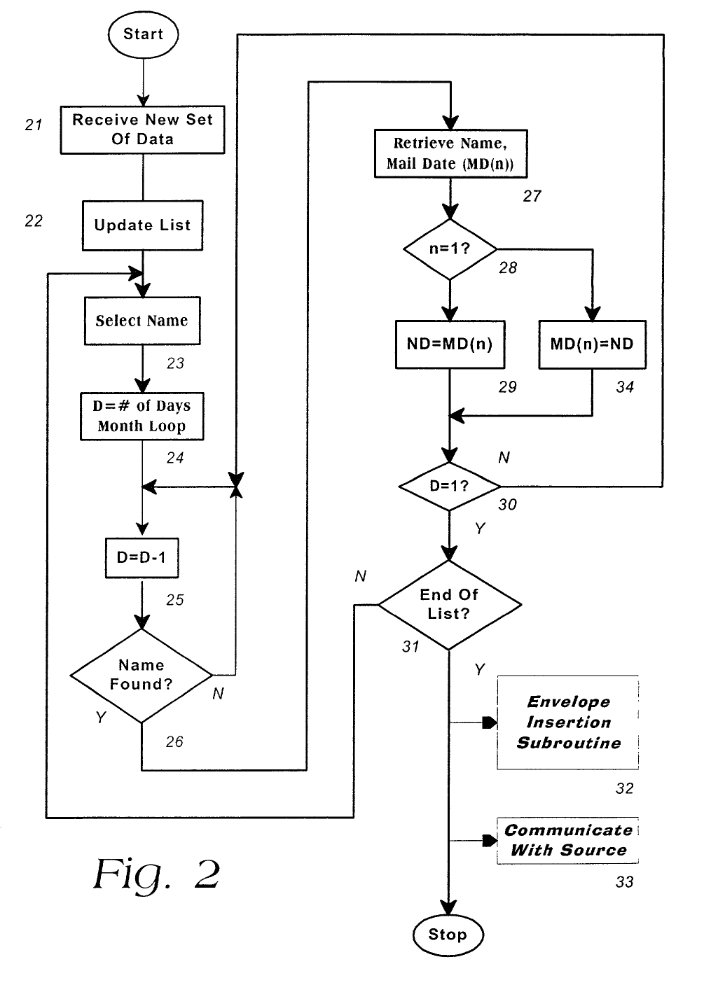

As illustrated in FIG. 2, the method and software of a first preferred embodiment of the invention begins at step 21 with the receipt of new data from one of the sources 1-5 of data or records for the mailings. For example, the new data might be the addition of new accounts, or changes in desired mailing dates. At step 22, the control program 8 updates the list contained in database 7 based on the new data, at which time the consolidation software 20 is run.

The goal of the method and software of this first embodiment of the invention is simply to locate every instance that a name occurs within the predetermined time period, illustrated as one month, re-schedule all of the mailings for a single day or time, and combine all mailings to a single address scheduled to occur on the single day or time into a single envelope. To accomplish this, software 20 first selects, or is provided with, a name or address on the mailing list. This step can be as simple as selecting names whose records have been updated, and/or selecting names in alphabetical order.

After selecting a name or address, software 20 initializes a loop at step 24 to check every day of a month, or other predetermined period of time, on which a mailing can occur and determine if a mailing is scheduled for the selected name on that day, and steps through the loop one day at a time by decrementing (or incrementing) a counter D (step 25). As illustrated in FIG. 2, counter D is set to cover one month, which is a typical mailing cycle, although it may only be desired to combine mailings within a two week, one week, or other period of time. The counter is decremented (or incremented) until the counter reaches 1 (or the last day in the combination period) as determined at step 30, at which point the program selects another name (step 31) or stops if there are no more names on the list.

In the illustrated example, during each loop n following the initial pass, the mailing date parameter MD(n) for a particular mailing is set to the mail date MD(1) retrieved on the first pass. This is accomplished by, upon location of the selected name (step 26), retrieving the associated record, and in particular the date MD(n) on which a mailing for the selected name is to occur (step 27). On the first pass, determined at step 28, a new date flag ND is set to the mail date MD(n) retrieved at step 27 (step 29), and the loop precedes to the next day or next name on the list. On subsequent passes, the mailing date associated with any records received is set to the mailing date of the first record retrieved (step 34), so that all of the records associated with the selected name have the same mail date.

Once a single mail date has been established for all mailings associated with the selected name, the control program 8 can use the revised mailing list to consolidate mailings by combining all mailings scheduled to occur on a single day into a single envelope, subject to any weight limitations on the envelopes (step 32). In addition, control program 8 may be required to report re-scheduled mail dates to one of divisions or units 1-5 responsible for origination of the mailing (step 33), either for verification that the re-scheduling is acceptable or to permit the source division or unit's records to reflect the re-scheduled mailing date.

Although the example illustrated in FIG. 2 re-schedules all mailings for the mailing date of the first record retrieved for the selected name, it will be appreciated that the date of the combined mailing could also be set to the mail date of the last retrieved name, the average or median of all retrieved mail dates, or a preselected mail date chosen for convenience or other factors unrelated to any of the mail dates of the mailings to be combined.

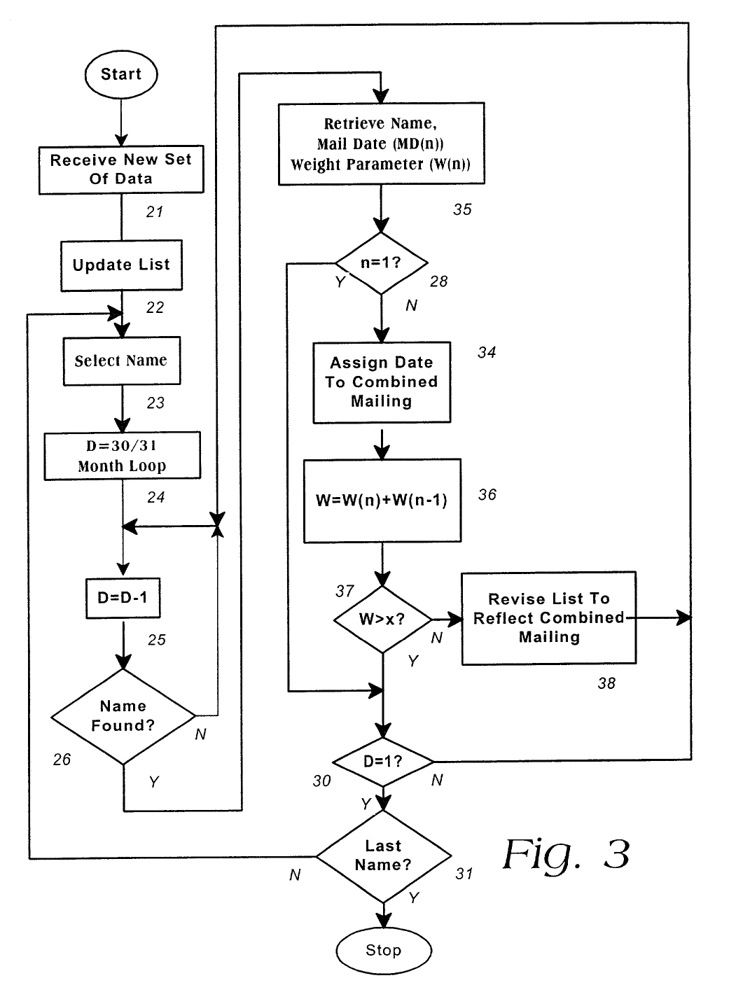

The method and software of the second preferred embodiment illustrated in FIG. 3 is similar to the method and software illustrated in FIG. 2, except that the mailing consolidation program 20 takes into document parameters W(n) related to the weight of the combined mailing during the re-scheduling process. The document parameters W(n) may include the weights of the documents, if available, or other parameters related to the weights of the documents, such as numbers of pages, types of paper, and/or other factors that may be used to derive a weight parameter for each mailing.

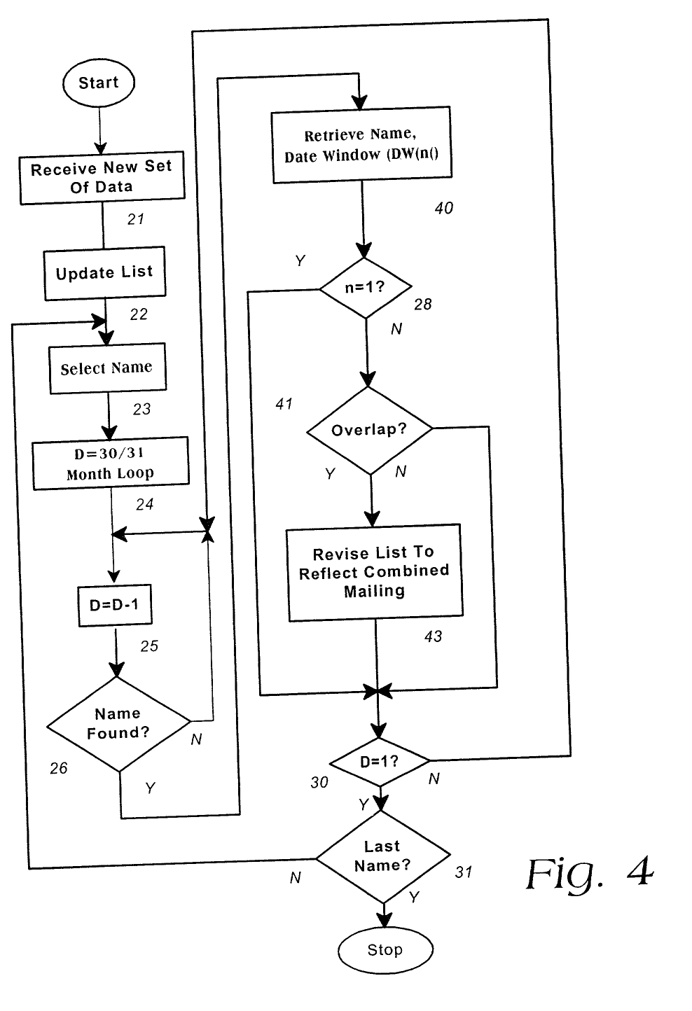

As illustrated in FIG. 3, steps 21-26 of the method and software of this embodiment may be identical to corresponding steps of the embodiment illustrated in FIG. 4, while record retrieval step 27 of the first preferred embodiment is replaced by a record retrieval step 35 in which not only a mail date MD(n) but also a weight-related parameter W(n) is retrieved. The weight-related parameters W(n) of each individual mailing to be included in the combined mailing are then processed, as necessary, and summed in step 36 until the total exceeds a predetermined limit x, as determined at step 37. The retrieved records are then stored together and/or marked for combination at step 38, for example by assigning a serial number to the combination and storing the serial number of the combined mailing together with the original records. After assembling a combined mailing, software 20 resumes the search for mailings to be combined.

In a modification of the method and software of the second preferred embodiment of the invention, the software can make multiple passes at the same set of data, starting at a different point in each pass, with the result that different combinations of mailings are assembled. These combinations can then be analyzed to determine which set of combinations results in the lowest overall cost based on such factors as envelope capacity, postal rates, presorting parameters, or the like, at which point the dates of the mailings to be combined are recorded and/or combined into a single record.

In the embodiment illustrated in FIG. 4, consolidation software 8 takes into account preferred mail dates, or windows outside of which re-scheduling of a mailing is not permitted, the preferred mail dates or date windows WD(n) being supplied by a source division or unit 1-5, or calculated according to predetermined criteria. For example, the source might require that a monthly statement be mailed out between 15 days and 10 days before a payment due date for a particular account, while an account statement with no due date might have a 10 day window, and a mailing of promotional material might have a wider window, but still be limited by the terms of offers contained within the promotional material.

To take into account such time restrictions, the method and software of the third preferred embodiment of the invention substitutes retrieval step 40, in which the date restrictions or windows are retrieved, for retrieval step 27 of FIG. 2, and adds step 41 which checks whether the windows of the mailings to be combined overlap. If an overlap is found, the mail date is adjusted to be within the overlap (step 42), and the corresponding records are stored together or otherwise marked for combined mailing on the adjusted date (step 43).

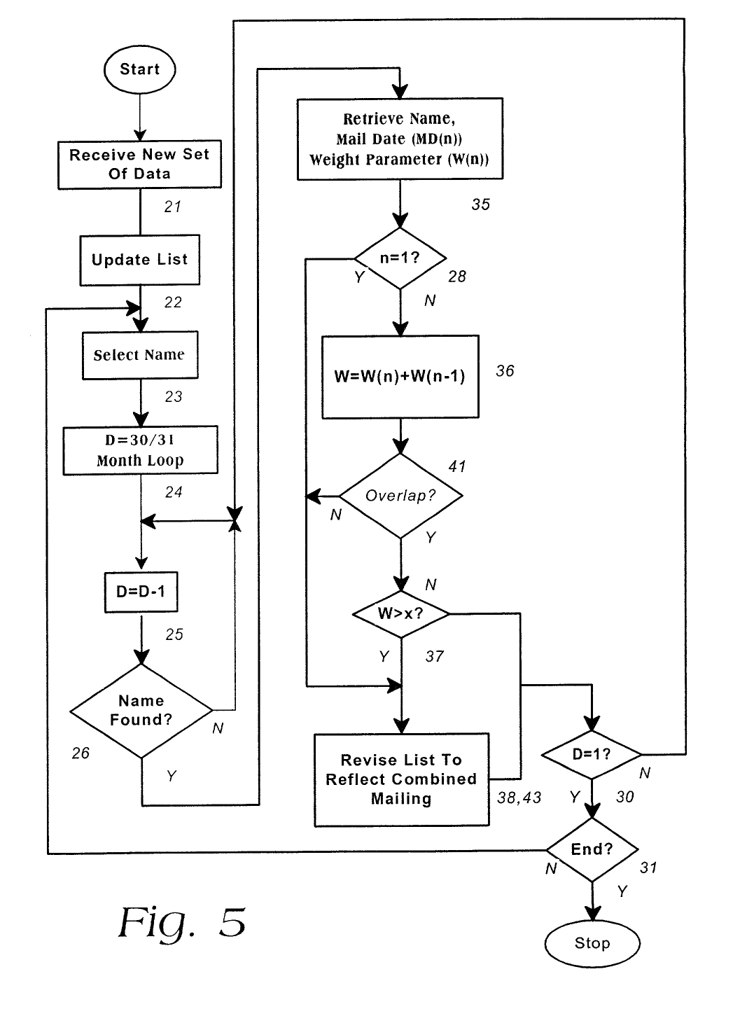

Finally, the method and software of the preferred embodiment of the invention may be modified to include both weight optimization and date restrictions on certain mailings, as illustrated in FIG. 5, all of the steps for which are described in detail in connection with FIGS. 2, 3, or 4. Again, each combination may be assigned a score, and multiple passes may be made to determine which set of combinations optimizes resource utilization, postage, or other cost-related mailing parameters.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention, and it is intended that the invention not be limited by the above description or accompanying drawings, but that it be defined solely in accordance with the appended claims.

We claim:

1. A system of consolidating mailings to decrease mailing costs, comprising:
a controller for maintaining a schedule of mailings, said mailings being originally scheduled to be sent separately, and said mailings including mailings having in common a destination address; and
software for re-scheduling said mailings having in common a destination address so that said re-scheduled mailings may be combined into a single mailing.

2. A system as claimed in claim 1, further comprising:
an addressing device for addressing envelopes; and
an inserter arranged to insert documents in said envelopes based on said schedule,
wherein said controller is arranged to control said addressing device and said inserter in order to assemble said re-scheduled combined mailings.

3. A system as claimed in claim 1, wherein said schedule further lists document parameters indicative of document weight, and wherein a number of mailings that are combined is limited by a total weight of the combined mailings.

4. A system as claimed in claim 1, wherein said schedule includes records containing data concerning preparation of documents to be included in said mailings, data concerning mailing dates, and address data, said data being provided by remote source computers linked to the computer by a network.

5. A system as claimed in claim 4, wherein the controller informs the source computers of changes in said schedule.

6. A system as claimed in claim 4, wherein said records include mailing date windows within which a mailing can occur, and said control program combines said mailings with reference to said mailing date windows.

7. A system as claimed in claim 1, wherein said system is arranged to check different combinations of said mailings, assign a cost score to each combination, and schedule said mailings by determining a lowest cost score.

8. A method of consolidating mailings to decrease mailing costs, comprising the steps of:
maintaining a schedule of mailings, said mailings being originally scheduled to occur at different times, and said mailings including mailings having in common a destination address; and
software for re-scheduling said mailings having in common a destination address so that said re-scheduled mailings may be combined into a single mailing.

9. A method as claimed in claim 8, further comprising the step of controlling an addressing device and an inserter in order to automatically assemble said combined mailings.

10. A method as claimed in claim 8, further comprising the steps of including in said schedule document parameters indicative of document weight, and limiting a number of mailings that are combined is based on a total weight of the combined mailings.

11. A method as claimed in claim 8, further comprising the step of including in said schedule records containing data concerning preparation of documents to be included in said mailings, data concerning mailing dates, an d address data, said data being provided by remote source computers linked to the computer by a network.

12. A method as claimed in claim 11, further comprising the step of having the controller inform the source computers of changes in said schedule.

13. A method as claimed in claim 11, wherein said records include mailing date windows within which a mailing can occur, and further comprising the step of having said control program combine said mailings with reference to said mailing date windows.

14. A method as claimed in claim 8, further comprising the step of different combinations of said mailings, assigning a cost score to each combination, and scheduling said mailings by determining a lowest cost score.

15. Software for consolidating mailings to decrease mailing costs,
wherein said software is applied to a schedule of mailings, said mailings being originally scheduled to occur at different times, and said mailings including mailings having in common a destination address, and
wherein said software re-schedules said mailings having in common a destination address so that said re-scheduled mailings may be combined into a single mailing.

16. Software as claimed in claim 15, wherein said schedule further lists document parameters indicative of document weight, and wherein said software limits a number of mailings to be combined by a total weight of the combined mailings.

17. Software as claimed in claim 15, wherein said schedule includes records containing data concerning preparation of documents to be included in said mailings, data concerning mailing dates, and address data, said data being provided by remote source computers linked to the computer by a network.

18. Software as claimed in claim 17, wherein said records include mailing date windows within which a mailing can occur, and said control program combines said mailings with reference to said mailing date windows.

19. Software as claimed in claim 15, wherein said software is arranged to check different combinations of said mailings, assign a cost score to each combination, and schedule said mailings by determining a lowest cost score.
